(19) United States
(12) Patent Application Publication
(10) Pub. No.: US 2017/0014301 A1
(43) Pub. Date: Jan. 19, 2017

(54) VIBRATING AND MASSAGING BED

(71) Applicant: JIA Leader Technology Co., Ltd., Taipei (TW)

(72) Inventor: Chun Fu LIN, Taipei (TW)

(21) Appl. No.: 14/800,789

(22) Filed: Jul. 16, 2015

(51) Int. Cl. A61H 23/02; A61G 7/018; A61G 7/005

(52) U.S. Cl. CPC A61H 23/0254; A61G 7/005; A61G 7/018; A61H 2201/0142; A61H 2201/50; A61H 2203/0456

(57) ABSTRACT

A vibrating and massaging bed includes a supporting base member having one or more spring biasing members for supporting a follower, an actuating device disposed in the supporting base member and connected to the follower for vibrating the follower relative to the supporting base member, a sliding member slidably engaged in the follower and a table supported on the sliding member, and another actuating device coupled to the sliding member for moving the sliding member and the table relative to the follower. A further actuating device is engaged in the sliding member and includes an actuating rod extendible out of the sliding member for tilting the table relative to the sliding member and the follower.

### BACKGROUND OF THE INVENTION

1. Field of the Invention

The present invention relates to a vibrating and massaging bed, and more particularly to a vibrating and massaging bed including an improved structure or configuration for providing various kinds of vibrating and massaging modes and for suitably and comfortably massaging the user.

2. Description of the Prior Art

Various kinds of typical massaging beds have been developed and provided for massaging the user and/or for rehabilitation purposes, and normally comprise a bed or table foldable or tiltable relative to a supporting base to different angular position, and/or movable relative to the supporting base for suitably massaging the user.

For example, U.S. Pat. No. 4,144,880 to Daniels, U.S. Pat. No. 4,751,754 to Bailey et al., U.S. Pat. No. 4,915,101 to Cuccia, U.S. Pat. No. 5,044,358 to Morin, U.S. Pat. No. 5,044,359 to Reinert, U.S. Pat. No. 5,125,884 to Weber et al., and U.S. Pat. No. 5,342,114 to Burke et al. disclose several of the typical massaging beds each comprise a bed or table foldable or tiltable relative to a supporting base to different angular position for supporting and/or massaging the user.

However, normally, the bed or table for supporting the user may only be folded or tiltable relative to the supporting base, but may not be moved or vibrated relative to the supporting base, such that the bed or table may not be used for vibrating and/or massaging the user.

U.S. Pat. No. 5,052,378 to Chitwood discloses another typical portable traction apparatus provided for applying patient controlled traction to the cervical spinal region, the lumbar spinal region or both simultaneously, intermittently or continuously over a given time period.

However, the user have to force and actuate and operate the traction apparatus by themselves, but may not be suitably and comfortably vibrated and massaged with the traction apparatus automatically.

The present invention has arisen to mitigate and/or obviate the afore-described disadvantages of the conventional vibrating and massaging beds.

### SUMMARY OF THE INVENTION

The primary objective of the present invention is to provide a vibrating and massaging bed including an improved structure or configuration for providing various kinds of vibrating and massaging modes and for suitably and comfortably massaging the user.

In accordance with one aspect of the invention, there is provided a vibrating and massaging bed comprising a supporting base member including at least one spring biasing member provided thereon, a follower disposed and engaged onto the at least one spring biasing member for being resiliently supported on the supporting base member and for allowing the follower to be vibrated relative to the supporting base member, a first actuating device disposed in the supporting base member and connected to the follower for vibrating the follower relative to the supporting base member, a sliding member slidably engaged in the follower and movable laterally relative to the follower, a table supported on the sliding member for supporting a user thereon, and a second actuating device disposed in the follower and coupled to the sliding member for moving or shaking the sliding member relative to the follower.

The first actuating device includes a flywheel rotatably supported in the supporting base member with a spindle, and a link connected between the flywheel and the follower for moving the follower relative to the supporting base member. The link includes one end pivotally coupled to the flywheel with an eccentric pin, the eccentric pin is offset from the spindle for allowing the follower to be moved relative to the supporting base member with the link and the flywheel.

The first actuating device includes a motor connected to the flywheel with a belt for allowing the flywheel to be rotated relative to the supporting base member by the motor and the belt. The first actuating device includes a control device electrically connected to the motor for controlling the motor and for actuating the motor to operate the flywheel.

The second actuating device includes a wheel rotatably supported in the follower with a shaft, and an lever connected between the sliding member and the wheel for moving the sliding member relative to the follower. The lever includes one end pivotally coupled to the wheel with an eccentric pin which is offset from the shaft for allowing the sliding member to be moved relative to the follower with the wheel and the lever.

The second actuating device includes a motor connected to the wheel with a belt for allowing the wheel to be rotated relative to the follower by the motor. The second actuating device includes a control device electrically connected to the motor for controlling the motor. The table includes a pillow supported on the table for engaging with the head of the user. The pillow includes an opening formed therein for engaging with the head of the user. The table includes a cushion disposed thereon.

A third actuating device may further be provided and engaged in the sliding member, and the third actuating device includes an actuating rod movably attached to the sliding member and extendible out of the sliding member for engaging with the table and for selectively tilting or inclining the table relative to the sliding member and the follower. The actuating rod is selected from a threaded rod.

The third actuating device includes a motorized device coupled to the actuating rod with a bevel gear mechanism for actuating and moving the actuating rod to engage with the table and to tilt the table relative to the sliding member and the follower and for suitably supporting the user on the table. The third actuating device includes a control device electrically connected to the motorized device for controlling the motorized device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a vibrating and massaging bed in accordance with the present invention;

FIG. 2 is a side plan schematic view of the vibrating and massaging bed;

FIGS. 3, 4, 5 are other side plan schematic views similar to FIG. 2, illustrating the operation of the vibrating and massaging bed;

FIG. 6 is another partial exploded view similar to FIG. 1, illustrating the other arrangement of the vibrating and massaging bed; and

FIG. 7 is a further side plan schematic view similar to FIGS. 2-5, illustrating the arrangement of the vibrating and massaging bed as shown in FIG. 6.

### DETAILED DESCRIPTION OF THE PREFERRED EMBODIMENT

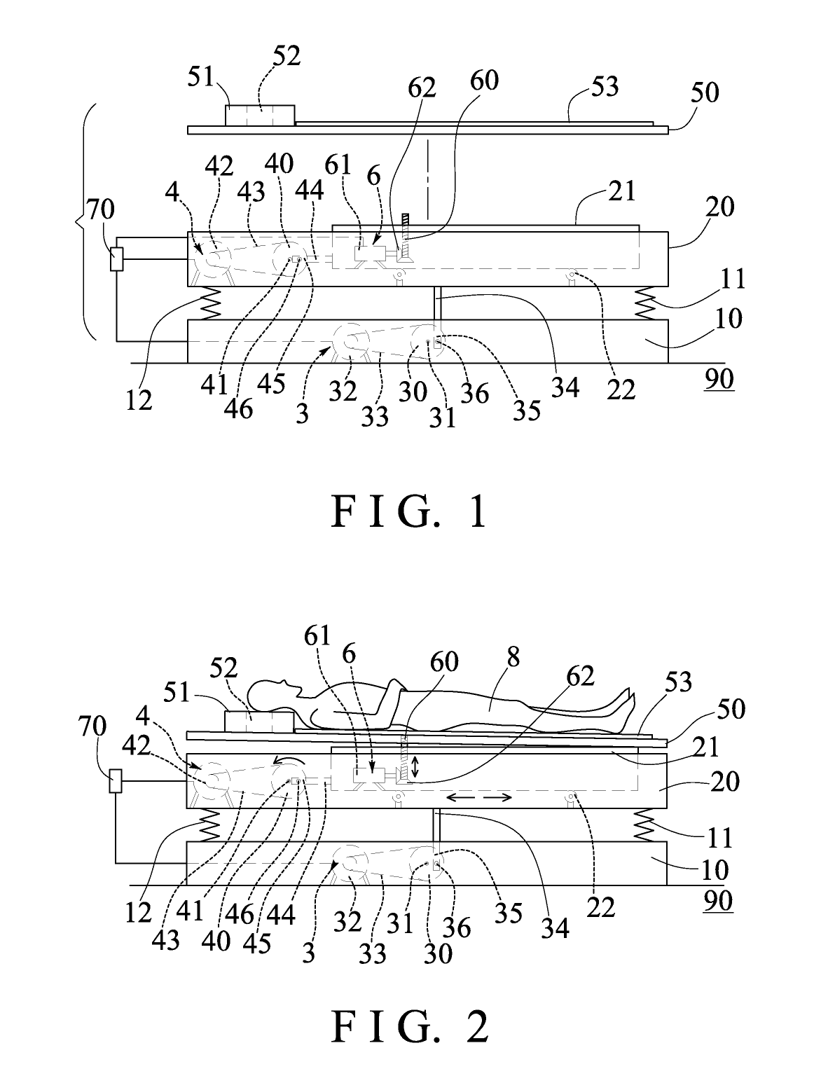

Referring to the drawings, and initially to FIGS. 1 and 2, a vibrating and massaging bed in accordance with the present invention comprises a supporting base member 10 for being supported on the ground or the supporting surface 90, and including one or more (such as four) spring biasing members 11, 12 disposed or provided thereon, such as disposed on the four corner areas thereof for resiliently supporting a table or follower 20 thereon and for allowing the follower 20 to be moved or vibrated relative to the supporting base member 10, a first operating or actuating device 3 is disposed or engaged in the supporting base member 10 and connected or coupled to the follower 20 for moving or vibrating the follower 20 relative to the supporting base member 10.

For example, the first actuating device 3 includes a follower or flywheel 30 rotatably attached or mounted or secured or supported in the supporting base member 10 with a spindle 31, a motor 32 connected or coupled to the flywheel 30 with a cable or belt 33 for allowing the flywheel 30 to be driven or rotated relative to the supporting base member 10 with or by the motor 32, and a link 34 is connected or coupled between the motor 32 and/or the flywheel 30 and the follower 20, for example, the link 34 has one end 35 pivotally or rotatably connected or coupled to the flywheel 30 with an eccentric pin 36 which is offset or spaced or separated from the spindle 31 for allowing the link 34 and thus the follower 20 to be moved or vibrated relative to the supporting base member 10 with or by the motor 32 and the flywheel 30 (FIG. 4).

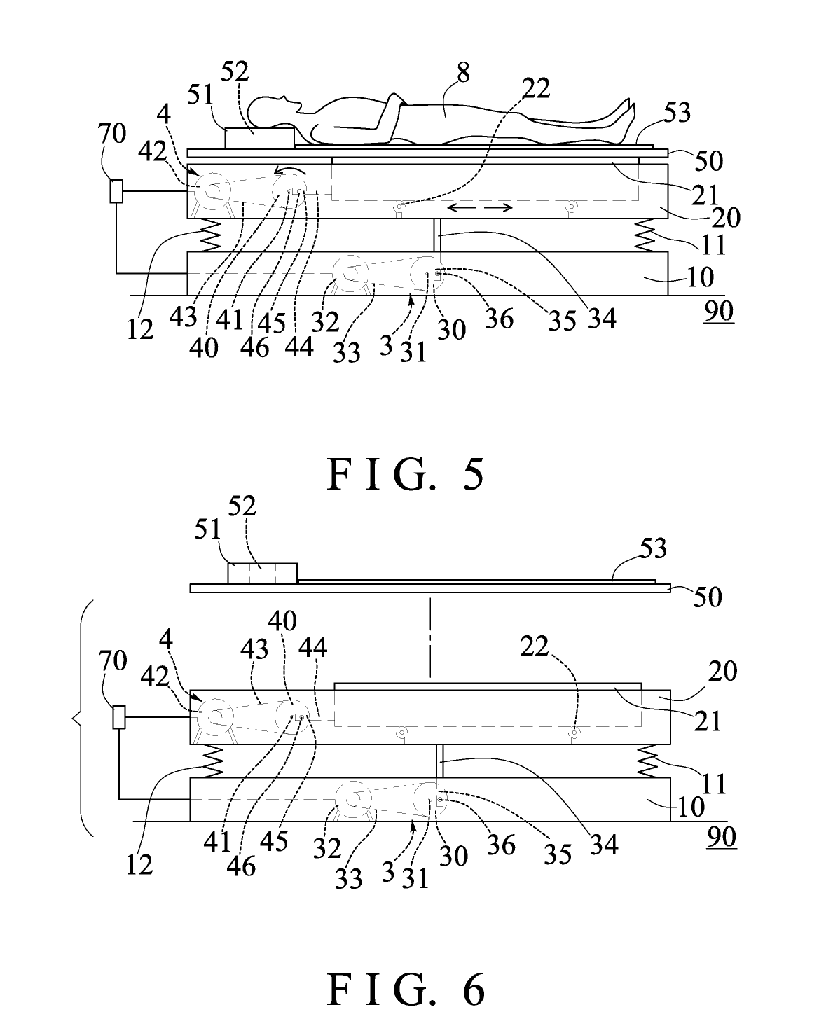

Another follower or sliding member 21 is slidably received or engaged in the follower 20 with one or more rollers 22 and movable laterally relative to the follower 20. Another or second operating or actuating device 4 is disposed or engaged in the follower 20 and connected or coupled to the sliding member 21 for moving or vibrating the sliding member 21 relative to the follower 20. For example, the second actuating device 4 includes a wheel 40 rotatably attached or mounted or secured or supported in the follower 20 with a shaft 41, a motor 42 connected or coupled to the wheel 40 with a cable or belt 43 for allowing the wheel 40 to be driven or rotated relative to the follower 20 with or by the motor 42, and a link or lever 44 is connected or coupled between the sliding member 21 and the motor 42 and/or the wheel 40, for example, the lever 44 has one end 45 pivotally or rotatably connected or coupled to the wheel 40 with an eccentric pin 46 which is offset or spaced or separated from the shaft 41 for allowing the lever 44 and thus the sliding member 21 to be moved or vibrated relative to the follower 20 with or by the motor 42 and the wheel 40 (FIG. 5).

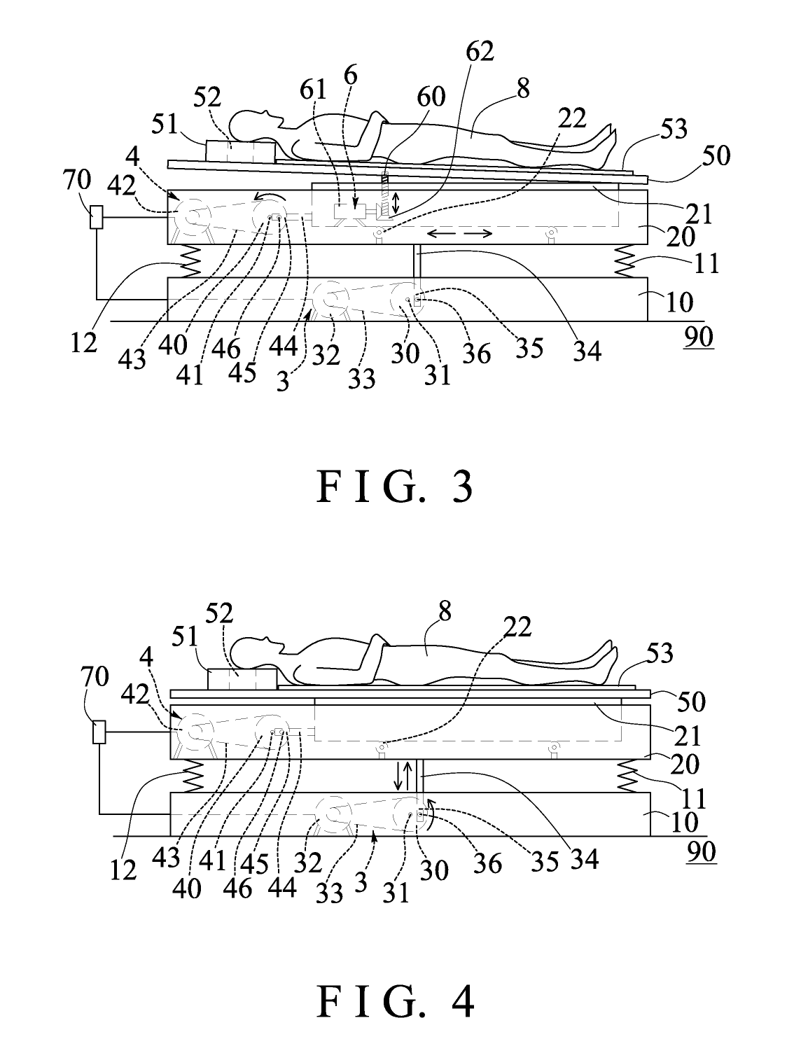

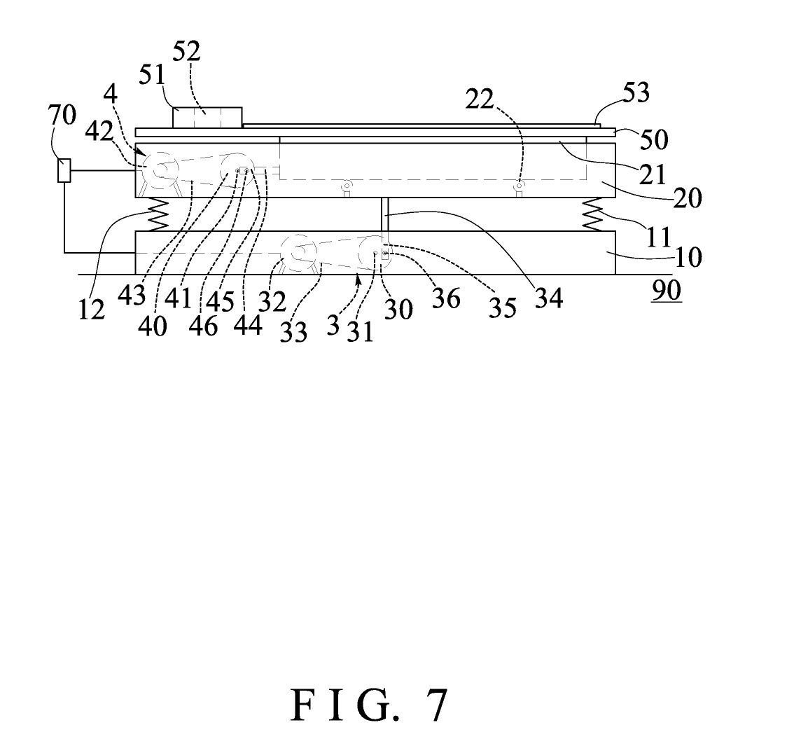

The vibrating and massaging bed in accordance with the present invention further includes a bed member or table 50 for supporting the user 8 thereon (FIGS. 2-5), and a pillow 51 disposed or supported on the table 50 for supporting the head and/or the neck portion of the user 8, it is preferable that the pillow 51 includes an opening 52 formed therein for receiving or engaging with the face of the user 8, particularly when the user 8 is faced down. The table 50 may further include a cushion 53 disposed or provided thereon for generating or providing a heat, such as a far infrared ray to the user 8 and for healing the user 8. The table 50 may be solidly and stably attached or mounted or secured or supported on the sliding member 21 (FIGS. 4-7), or tiltable relative to the sliding member 21 (FIGS. 2-3).

For example, as shown in FIGS. 1-3, a further or third operating or actuating device 6 is disposed or engaged in the sliding member 21 and includes an actuating rod 60, such as a threaded rod 60 movably attached or mounted or secured to the sliding member 21 and extendible out of the sliding member 21 for engaging with the table 50 and for selectively tilting or inclining the table 50 relative to the sliding member 21 and the follower 20 (FIGS. 2, 3). The third actuating device 6 includes a motor or motorized device 61 connected or coupled to or engaged with the actuating rod 60 with a bevel gear mechanism 62 for rotating or driving the actuating rod 60 and for actuating and moving the actuating rod 60 to engage with the table 50 and to selectively tilt or incline the table 50 relative to the sliding member 21 and the follower 20.

The vibrating and massaging bed in accordance with the present invention further includes a processing unit or control mechanism or device 70 electrically connected or coupled to the motorized device 61 of the third actuating device 6 and/or the motor 42 of the second actuating device 4 and/or the motor 32 of the first actuating device 3 for actuating or operating or vibrating the follower 20 relative to the supporting base member 10, or for actuating or operating or vibrating or shaking the sliding member 21 relative to the follower 20, or for actuating or operating or tilting or inclining the table 50 relative to the sliding member 21 and the follower 20. The third actuating device 6 is optionally provided and engaged in the sliding member 21 (FIGS. 1-3) and/or shielded or stored within the sliding member 21 (FIGS. 4-7).

Accordingly, the vibrating and massaging bed in accordance with the present invention includes an improved structure or configuration for providing various kinds of vibrating and massaging modes and for suitably and comfortably massaging the user.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A vibrating and massaging bed comprising:
a supporting base member including at least one spring biasing member provided thereon,
a follower disposed and engaged onto said at least one spring biasing member for being resiliently supported on said supporting base member and for allowing said follower to be vibrated relative to said supporting base member,
a first actuating device disposed in said supporting base member and connected to said follower for vibrating said follower relative to said supporting base member,
a sliding member slidably engaged in said follower and movable laterally relative to said follower,
a table supported on said sliding member, and
a second actuating device disposed in said follower and coupled to said sliding member for moving said sliding member relative to said follower.

2. The vibrating and massaging bed as claimed in claim 1, wherein said first actuating device includes a flywheel rotatably supported in said supporting base member with a spindle, and a link connected between said flywheel and said follower for moving said follower relative to said supporting base member.

3. The vibrating and massaging bed as claimed in claim 2, wherein said link includes one end pivotally coupled to said flywheel with an eccentric pin, said eccentric pin is offset from said spindle for allowing said follower to be moved relative to said supporting base member with said link and said flywheel.

4. The vibrating and massaging bed as claimed in claim 2, wherein said first actuating device includes a motor connected to said flywheel with a belt for allowing said flywheel to be rotated relative to said supporting base member by said motor.

5. The vibrating and massaging bed as claimed in claim 4, wherein said first actuating device includes a control device electrically connected to said motor.

6. The vibrating and massaging bed as claimed in claim 1, wherein said second actuating device includes a wheel rotatably supported in said follower with a shaft, and an lever connected between said sliding member and said wheel for moving said sliding member relative to said follower.

7. The vibrating and massaging bed as claimed in claim 6, wherein said lever includes one end pivotally coupled to said wheel with an eccentric pin which is offset from said shaft for allowing said sliding member to be moved relative to said follower with said wheel and said lever.

8. The vibrating and massaging bed as claimed in claim 6, wherein said second actuating device includes a motor connected to said wheel with a belt for allowing said wheel to be rotated relative to said follower by said motor.

9. The vibrating and massaging bed as claimed in claim 8, wherein said second actuating device includes a control device electrically connected to said motor.

10. The vibrating and massaging bed as claimed in claim 1, wherein said table includes a pillow supported on said table.

11. The vibrating and massaging bed as claimed in claim 10, wherein said pillow includes an opening formed therein.

12. The vibrating and massaging bed as claimed in claim 1, wherein said table includes a cushion disposed thereon.

13. The vibrating and massaging bed as claimed in claim 1 further comprising a third actuating device engaged in said sliding member, and said third actuating device includes an actuating rod movably attached to said sliding member and extendible out of said sliding member for engaging with said table and for tilting said table relative to said sliding member and said follower.

14. The vibrating and massaging bed as claimed in claim 13, wherein said actuating rod is selected from a threaded rod.

15. The vibrating and massaging bed as claimed in claim 13, wherein said third actuating device includes a motorized device coupled to said actuating rod with a bevel gear mechanism for actuating and moving said actuating rod to engage with said table and to tilt said table relative to said sliding member and said follower.

16. The vibrating and massaging bed as claimed in claim 15, wherein said third actuating device includes a control device electrically connected to said motorized device.
